(19) United States
(12) Patent Application Publication
(10) Pub. No.: US 2001/0011859 A1
(43) Pub. Date: Aug. 9, 2001

(54) ULTRASONIC MOTOR AND ELECTRONIC DEVICE WITH ULTRANSONIC MOTOR

(76) Inventors: TAKASHI YAMANAKA, CHIBA-SHI (JP); MASAO KASUGA, CHIBA-SHI (JP); AKIHIRO IINO, CHIBA-SHI (JP); KENJI SUZUKI, CHIBA-SHI (JP)

Correspondence Address: ADAMS & WILKS, 50 BROADWAY, 31ST FLOOR, NEW YORK, NY, 10004

(21) Appl. No.: 09/143,318

(22) Filed: Aug. 28, 1998

(30) Foreign Application Priority Data
Aug. 29, 1997 (JP) 9-235233

(51) Int. Cl. H02N 2/00

(52) U.S. Cl. 310/323.09; 310/316.02; 310/323.04; 310/323.05

(57) ABSTRACT

An ultrasonic motor driven by a self-oscillation circuit which can be mounted in an electronic device without imposing structural restrictions on the electronic device and can thus be used easily. Among an oscillating member for generating an oscillatory wave, a pressing mechanism for causing a moving body to make pressing contact with the oscillating member, a moving body frictionally driven by the oscillatory wave, and outputting means for transmitting an output from the moving body to the outside, at least one member is made of an insulating material, and when in particular the moving body is provided with outputting means for transmitting an output torque this outputting means is made of an insulating material and no restrictions are imposed on the shapes and the materials of the oscillating member and the moving body, which closely relate to the output performance of the ultrasonic motor.

### BACKGROUND OF THE INVENTION

This invention relates to an ultrasonic motor for frictionally driving a moving body by ultrasonic vibration and to an insulating structure of an electronic device using an ultrasonic motor.

Electronic devices having a built-in ultrasonic motor as a motive power source have been in use. For example, FIG. 11 is a sectional view showing the construction of an electronic device wherein an ultrasonic motor is used as a motive power source of an analog electronic clock. An oscillating body 3 having a piezoelectric device 4 bonded thereto is made to generate an oscillatory wave by self-oscillation to drive a moving body 5. An ultrasonic motor of this kind of construction is disclosed for example in Japanese Unexamined Patent Publication No. H.8-251952.

However, in this analog electronic clock, a base plate 21 is directly connected to the plus side of a terminal of a power supply for driving the clock and doubles as a lead wire for carrying a plus potential to the movement circuit. When an ultrasonic motor is mounted on this base plate 21, electrodes of the piezoelectric device short-circuit with the plus side power supply terminal through the base plate 21 and stable driving becomes impossible. Consequently, to mount a self-oscillation circuit, which can be small and have an excellent frequency follow-up characteristic, as a driving circuit of an ultrasonic motor, in related art constructions there has been the restriction that it is necessary to make the base plate insulating or provide a separate insulating structure.

This is because an oscillating member, a moving body, outputting means and a pressing mechanism constituting the ultrasonic motor are made with conducting materials only, and a current path is formed between at least one of the electrodes of the piezoelectric device and at least one of the power supply terminals and makes driving impossible. Therefore, it becomes necessary for the current path between the power supply and the ultrasonic motor to be cut by components constituting the electronic device. However, this imposes restrictions on the makeup and the structure of the electronic device in which the ultrasonic motor is mounted, and furthermore in a small electronic device in which it is difficult to provide an insulating structure there are also space restrictions and it may consequently be impossible to mount an ultrasonic motor at all.

### SUMMARY OF THE INVENTION

It is therefore an object of the present invention to provide an ultrasonic motor which can be mounted in an electronic device without imposing structural restrictions on the electronic device and is therefore easy to use.

To achieve this and other objects, the invention provides an ultrasonic motor wherein, among an oscillating member for generating an oscillatory wave, a pressing mechanism for pressing the oscillating member against a moving body, a moving body frictionally driven by the oscillatory wave, and outputting means for transmitting an output from the moving body to the outside, at least one member is made an insulating member.

As the operation of the invention, by a current path between a power supply terminal and an electrode formed on a piezoelectric device being cut by at least one of the above-mentioned members constituting the ultrasonic motor, it is possible to realize an ultrasonic motor which does not impose structural restrictions on a device in which it is mounted and which is therefore easy to use.

In particular, according to the invention, when outputting means for transmitting an output torque is provided on the moving body, the problem described above can be solved by this outputting means being made from an insulating material, and with this construction the above-mentioned object can be achieved without imposing restrictions on the shapes and the materials of the oscillating member and the moving body, which relate closely to the output performance of the ultrasonic motor.

### BRIEF DESCRIPTION OF THE DRAWINGS

FIG. 1 is a block diagram showing a first preferred embodiment of an ultrasonic motor according to the invention;

FIG. 2 is a sectional view showing the construction of the first preferred embodiment;

FIG. 3 is a block diagram showing a second preferred embodiment of an ultrasonic motor according to the invention;

FIG. 4 is a sectional view showing the construction of the second preferred embodiment;

FIG. 5 is a block diagram showing a third preferred embodiment of an ultrasonic motor according to the invention;

FIG. 6 is a sectional view showing the construction of the third preferred embodiment;

FIG. 7 is a block diagram showing a fourth preferred embodiment of an ultrasonic motor according to the invention;

FIG. 8 is a sectional view showing the construction of the fourth preferred embodiment;

FIG. 9 is a sectional view showing a fifth preferred embodiment of an ultrasonic motor according to the invention;

FIG. 10 is a sectional view showing the construction of the fifth preferred embodiment; and

FIG. 11 is a sectional view of an electronic device in which an ultrasonic motor of related art has been used.

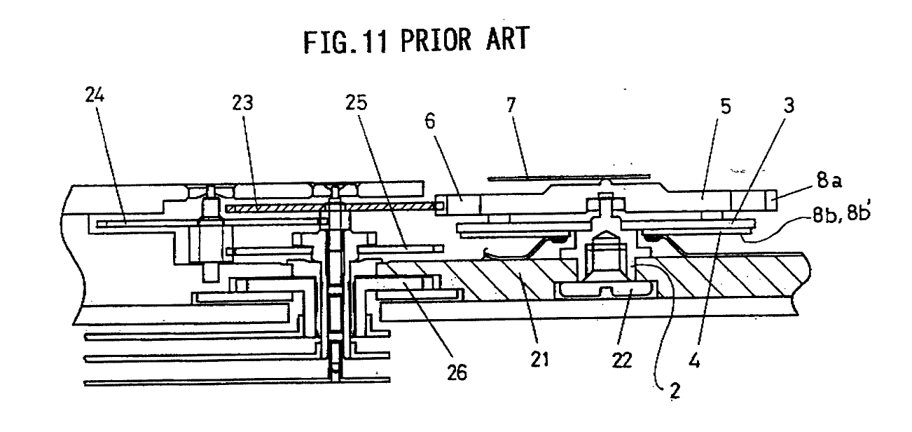

### DETAILED DESCRIPTION OF THE PREFERRED EMBODIMENTS

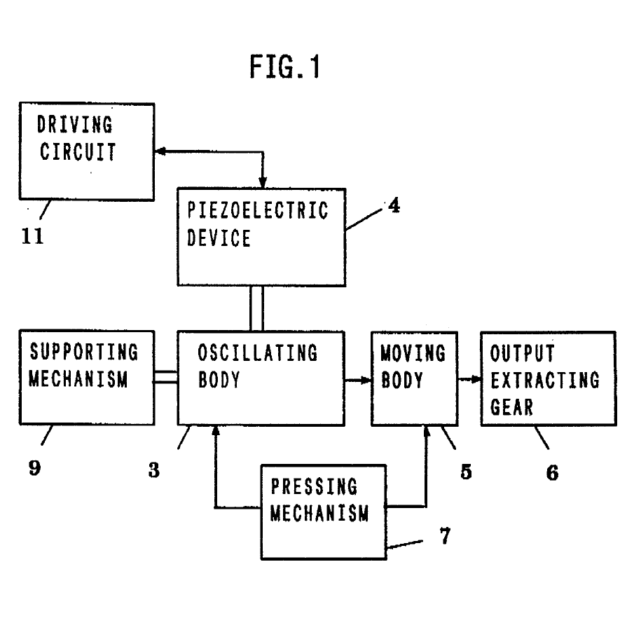

Preferred embodiments of the invention will now be described in detail with reference to FIG. 1 through FIG. 10.

First Preferred Embodiment

FIG. 1 is a block diagram showing a first preferred embodiment of an ultrasonic motor according to the invention. In this preferred embodiment, a current path between a power supply 10 included in a driving circuit 11 and an ultrasonic motor is cut so that no structural restrictions are imposed on an electronic device in which the ultrasonic motor is mounted.

A driving signal generated by the driving circuit 11 is impressed on a piezoelectric device 4. This driving signal causes the piezoelectric device 4 to oscillate, and a displacement magnification and a displacement direction are determined by an oscillating body 3 to which the piezoelectric device 4 is bonded. A moving body 5 having its movement direction confined by a supporting mechanism 9 and pressed against the oscillating body 3 by a pressing mechanism 7 is moved by the oscillation of the oscillating body 3, and an output is extracted to the outside by an output extracting gear 6.

The specific construction of this preferred embodiment will now be described.

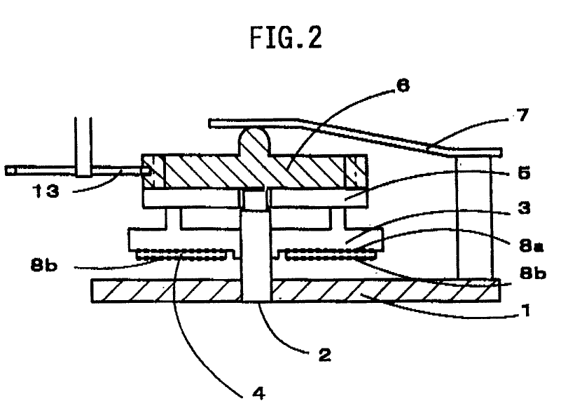

FIG. 2 is a view showing the construction of this first preferred embodiment of an ultrasonic motor according to the invention.

A supporting plate 1 is made of an insulating material, and a center shaft 2 mounted on the supporting plate 1 is completely cut off from outside currents. A piezoelectric device 4 having electrode patterns 8a, 8b, 8b′ provided on its front and rear sides is bonded to an oscillating body 3 fixed to this center shaft 2. Also, a moving body 5 is rotatably mounted on the center shaft 2, and the moving body 5 is pressed against the oscillating body 3 by a pressing spring 7 mounted on the supporting plate 1. The driving circuit 11 impresses on the piezoelectric device 4 through the electrode patterns 8a, 8b, 8b′ a driving signal enabling the generation of a progressive wave or a standing wave such that the oscillating body 3 oscillates in the circumferential direction with a secondary oscillation mode. As a result, the piezoelectric device 4 oscillates and the moving body 5 rotates about the center shaft 2. A gear 6 made of insulating plastic and serving as outputting means is provided on the moving body 5. Here, the gear 6 is a separate member from the moving body 5, but alternatively it may be molded integrally with the moving body 5. Also, this outputting means does not have to be a gear, and a frictional transmission mechanism using pulleys and a V-belt or the like may alternatively be used. The rotational movement of the moving body 5 is extracted to the outside by this gear 6. Because the output extracting gear 6 and the supporting plate 1 are made of insulating materials, the current path between the ultrasonic motor and the power supply 10 is cut. Consequently there are no restrictions when the ultrasonic motor is mounted in an electronic device, and furthermore an ultrasonic motor which is resistant to external noise and easy to handle can be obtained.

The method by which the current path between the power supply 10 and the ultrasonic motor is cut is not limited to this method of making the output extracting gear 6 and the supporting plate 1 insulating members as shown in FIG. 2, and it is only necessary for at least one member among the oscillating member, the pressing mechanism, the moving body and the outputting means constituting the current path to be made an insulating member.

Effects of the invention will now be explained.

An alternating voltage is impressed on the electrodes provided on the front and rear sides of the piezoelectric device 4 by the driving circuit 11, and the moving body 5 is driven by way of friction by an oscillatory wave generated in the oscillating body 3 as a result. In the related art, when an ultrasonic motor is mounted in an electronic device, if the case of the device or parts constituting the device are electrically shorted with at least one of the power supply terminals, the electrodes of the piezoelectric device are shorted with the power supply terminal through the outputting means and the supporting plate of the ultrasonic motor, and stable driving becomes impossible.

In this first preferred embodiment of the invention, on the other hand, as a result of the supporting plate 1 and the gear 6 being made of insulating materials, the electrodes of the piezoelectric device can be electrically isolated from members outside the ultrasonic motor and thus it is possible to realize stable driving without this being affected by the construction of the device in which the ultrasonic motor is mounted.

From the above, with this preferred embodiment, because the current path between the power supply 10 and the ultrasonic motor is cut by members constituting the ultrasonic motor only, mechanisms of the related art for cutting the current path between the power supply 10 and the ultrasonic motor can be dispensed with and an ultrasonic motor which does not impose structural restrictions on the electronic device in which it is mounted and which is easy to use is realized.

Second Preferred Embodiment

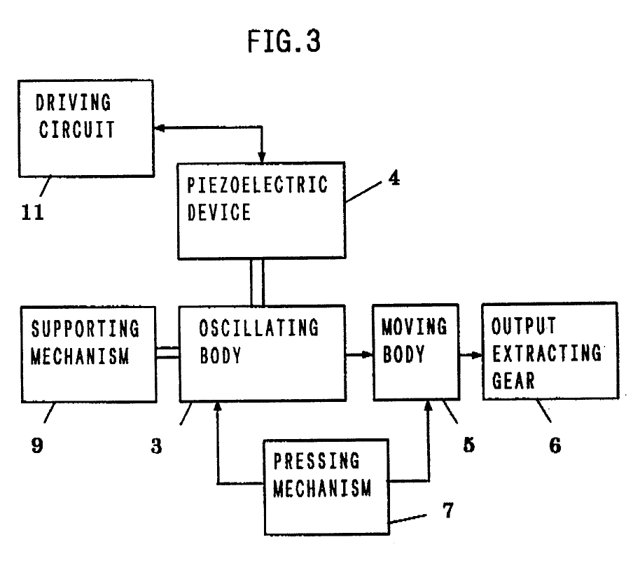

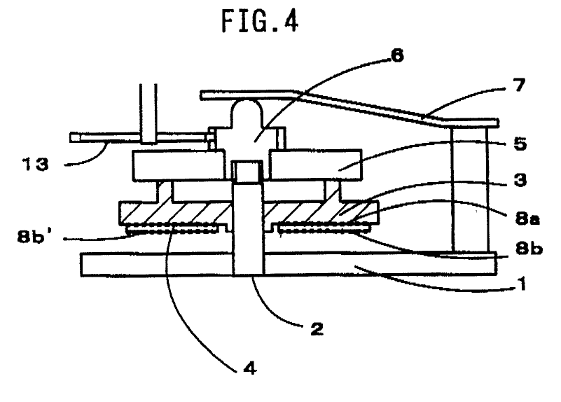

FIG. 3 is a block diagram and FIG. 4 a specific construction view of a second preferred embodiment of an ultrasonic motor according to the invention.

This preferred embodiment is basically the same as the first preferred embodiment, but has the feature that the oscillating body 3 to which the piezoelectric device 4 having the electrode patterns 8a, 8b, 8b′ is bonded is made of insulating plastic.

In this case, because the oscillating body 3 is made an insulating member, it cuts the current path between the power supply 10 and the ultrasonic motor and even if the supporting plate 1, the center shaft 2 and the moving body 5 are made with conducting materials there is no influence on the driving of the ultrasonic motor. Consequently, no structural restrictions are imposed on an electronic device in which the ultrasonic motor is mounted and in the designing of the ultrasonic motor itself the materials to be used can be selected more freely.

Also, because the oscillating body 3 is made of insulating plastic, a complicated machining process becomes unnecessary and considerable cost reductions are possible through improvements in manufacturability.

Third Preferred Embodiment

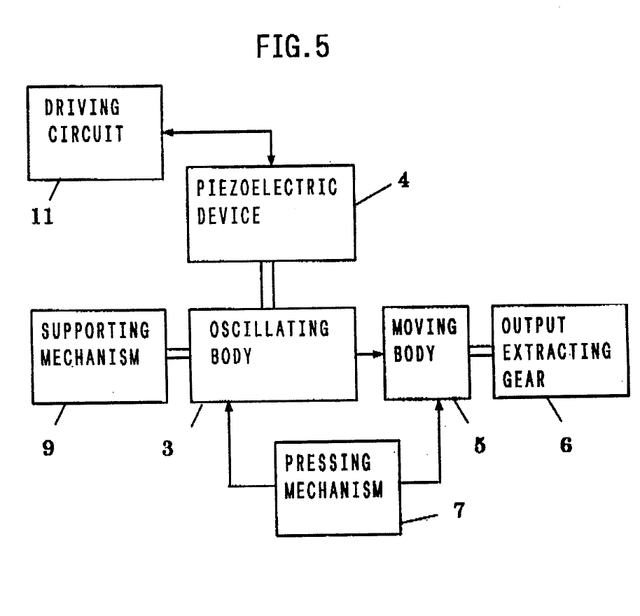

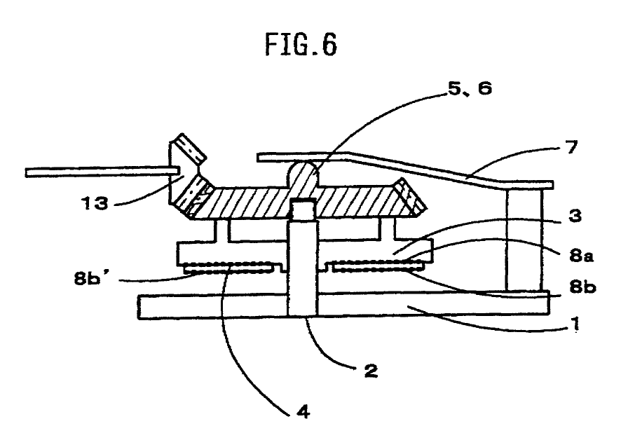

FIG. 5 is a block diagram and FIG. 6 a specific construction view of a third preferred embodiment of an ultrasonic motor according to the invention.

This preferred embodiment is basically the same as the first preferred embodiment but has the feature that the supporting plate 1 and the moving body 5 and the output extracting gear 6 are made of insulating plastic and the moving body 5 and the gear 6 are molded integrally.

Here, because the contacting surfaces of the supporting plate 1 and the oscillating body 3 are insulating, the current path between the power supply 10 and the ultrasonic motor is cut and no structural restrictions are imposed on an electronic device in which the ultrasonic motor is mounted.

As a result of them being integrally molded a step of assembling the moving body 5 and the output extracting gear 6 can be dispensed with, the process of manufacturing the moving body 5 and the output extracting gear 6 can be simplified, and considerable improvements in the manufacturability of the ultrasonic motor can thereby be made.

Also, as a result of the moving body 5 and the gear 6 being integrally molded, the freedom of choice of the output extraction method increases, and for example by making the moving body thin compared to the moving body shown in FIG. 2 and making the gear a bevel gear, as shown in FIG. 6, a function of converting the direction of the output can be further given to the output extracting means and it becomes possible for the orientation in which the ultrasonic motor is mounted in an electronic device to be selected variously.

Also, when the moving body 5 molded-integrally with the output extracting gear 6 is reinforced with glass fiber, glass beads or mica, because the reinforcing material is an insulating material, it is possible to improve the durability and the moldability of the integrally molded moving body 5 while maintaining its insulativity.

Here, a material having a volume resistivity of 10⁵ Ω -cm or more is used as the insulating material.

Fourth Preferred Embodiment

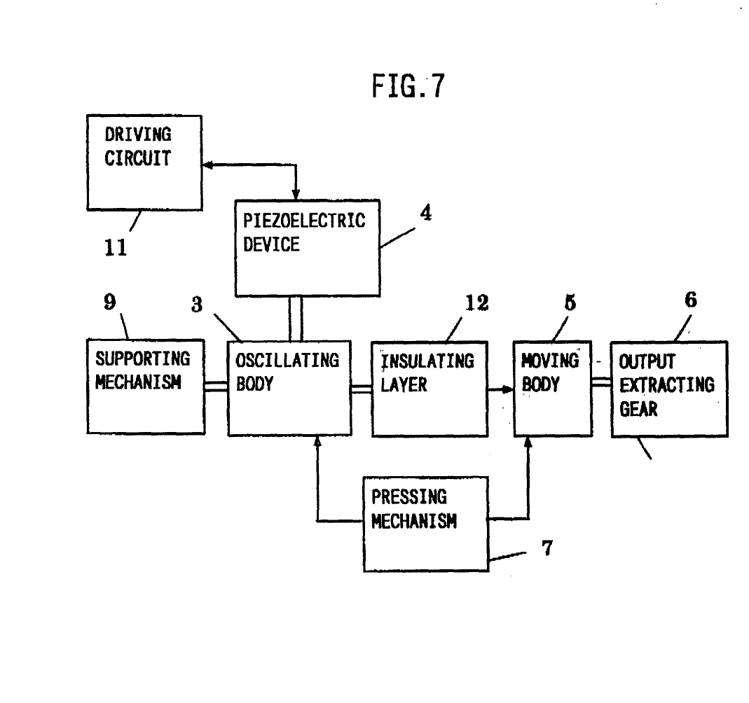

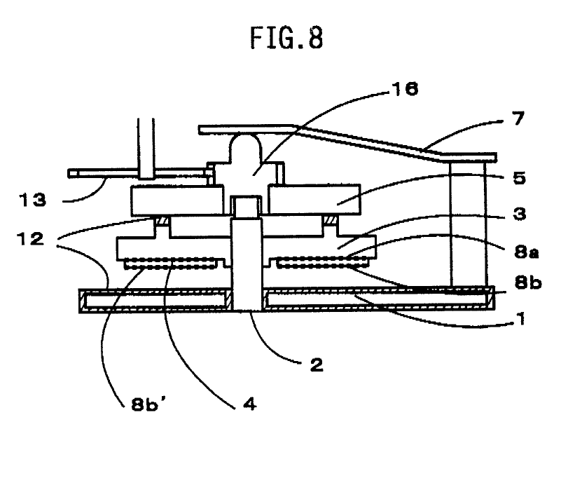

FIG. 7 is a block diagram and FIG. 8 a specific construction view of a fourth preferred embodiment of an ultrasonic motor according to the invention.

This preferred embodiment is basically the same as the first preferred embodiment but has the feature that an insulating layer 12 is formed on the supporting plate 1 and on the surfaces of a metal oscillating body 3 which make pressing contact with the moving body 5.

Any suitable method can be used for forming this insulating layer, such as transforming the materials of the oscillating body 3 or coating, adhering, cladding, fusing or chemically bonding an insulating material to the oscillating body 3.

With this preferred embodiment, because an insulating layer is provided on the contacting surfaces of the supporting plate 1 and the metal oscillating body 3, the current path between the power supply 10 and the ultrasonic motor is cut and no structural restrictions are imposed on an electronic device in which the ultrasonic motor is mounted.

And, because as long as they are materials which can be provided with an insulating layer the materials of the supporting plate 1 and the oscillating body 3 can be selected freely, this is advantageous in the design of the ultrasonic motor.

Here, the insulating layer 12 is made of an engineering ceramic such as alumina, zirconia, silicon-nitride, titanium nitride or DLC (diamond-like carbon) or of an insulating plastic, or an oscillating body 3 having improved insulativity and wear resistance is made by using aluminum or an aluminum alloy and carrying out alumite processing on the contacting surfaces of the oscillating body 3 against which the moving body 5 presses to provide the insulating layer 12.

Fifth Preferred Embodiment

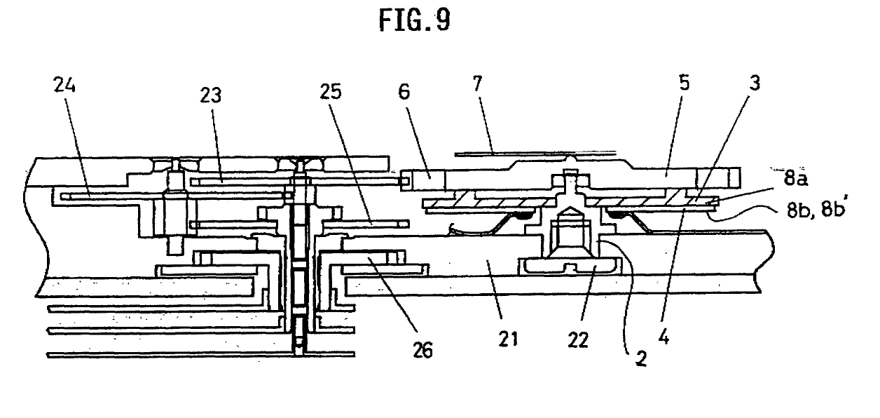

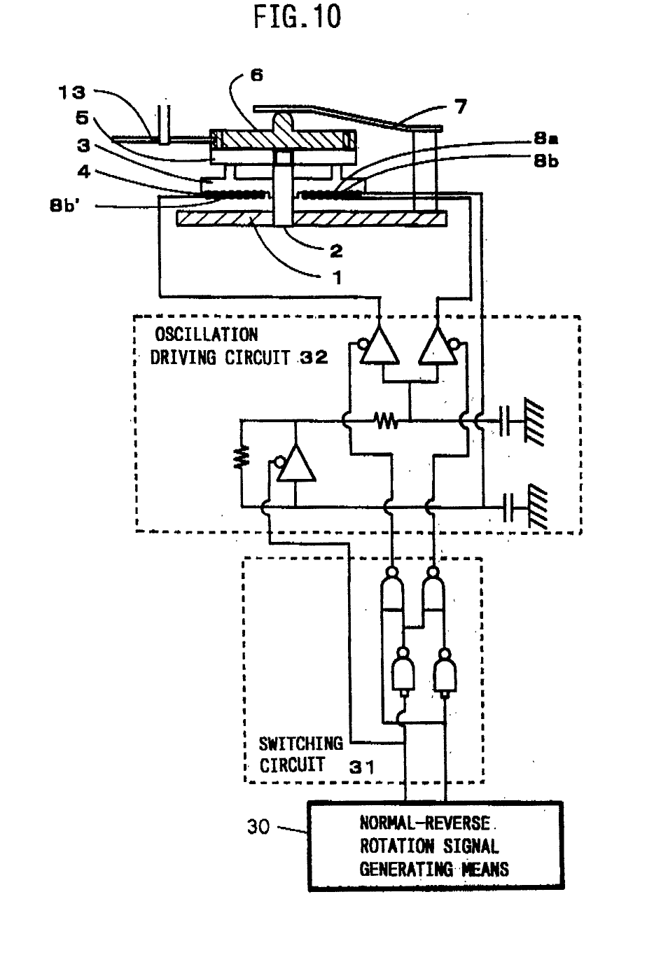

FIG. 9 is specific construction view of a fifth preferred embodiment of an ultrasonic motor according to the invention, and FIG. 10 is a diagram of an example of a self-oscillation circuit for driving an ultrasonic motor according to the invention. As shown in FIG. 10, it is possible to drive an ultrasonic motor according to the invention by transmitting an signal oscillated in an oscillation driving circuit 32 to electrode pattern 8a, 8b, 8b′. Also, it is possible to decide which electrode pattern among electrode pattern 8a, 8b, 8b′ a driving signal is transmitted to by transmitting an signal from a normal-reverse rotation signal generating means 30 to a switching circuit 31.

In this preferred embodiment, an ultrasonic motor according to the invention is used as a motive power source of an analog electronic clock.

An insulating plastic oscillating body 3 of the kind shown in previous preferred embodiments is mounted on a center shaft 2, and this center shaft 2 is fixed to a base plate 21 by a fastening screw 22. A piezoelectric device 4 having electrode patterns 8a, 8b, 8b′ provided on its front and rear sides is bonded to the oscillating body 3. Also, the moving body 5 is rotatably mounted on the center shaft 2, and the moving body 5 is pressed against the oscillating body 3 by a pressing spring 7 mounted on the base plate 21. An insulating plastic gear 6 serving as outputting means is disposed on the moving body 5, and this gear 6 rotates a number four gear 23 and further rotates a number three gear 24, a minute gear 25, a day back gear (not shown) and a tube gear 26 at fixed speeds.

If the period of the alternating voltage applied to the. piezoelectric device 4 and the numbers of teeth of the above-mentioned gears are set at predetermined values, the hour can be displayed by an hour hand attached to the tube gear 26, the minute by a minute hand attached to the minute gear 25 and the second, by a second hand attached to the number four gear 23, whereby the time can be displayed.

In this electronic clock, the base plate 21 is connected to a plus side power supply terminal, and consequently in related art constructions there has been the restriction that a separate insulating structure must be provided by for example making the base plate 21 and the number four gear 23 out of insulating plastic. With an ultrasonic motor according to the present invention, on the other hand, because the oscillating body 3 is an insulating member, the current path between the power supply 10, in this case the plus side terminal thereof connected to the base plate 21, and the ultrasonic motor is cut, no restriction that for example the number four gear 23 for transmitting the output torque of the ultrasonic motor from the outputting means must be given an insulating structure is imposed, and the ultrasonic motor -can therefore be mounted easily.

Thus, an ultrasonic motor according to the invention can be mounted in an electronic device without structural restrictions being imposed on the electronic device and it is possible to obtain an ultrasonic motor which is easy to use and can be used in a wide range of applications.

What is claimed is:

1. An ultrasonic motor comprising:
a driving circuit for driving an oscillatory wave;
a power source for powering the driving circuit;
an oscillating member for generating an oscillatory wave driven by the driving circuit;
a moving body making contact with the oscillating member and moved by the oscillatory wave generated by the oscillating member; and
a pressing mechanism for causing the moving body to make pressing contact with the oscillating member,
wherein among the oscillating member, the pressing mechanism and the moving body, at least one member constituting a current path between at least one terminal of the power source and at least one electrode of a piezoelectric device is made of an insulating material.

2. An ultrasonic motor according to claim 1, wherein the moving body is made up of a moving body proper and outputting means for extracting an output of the moving body and at least one member among the moving body proper, the outputting means, the oscillating member and the pressing mechanism is made of an insulating material.

3. An ultrasonic motor according to claim 1, wherein the moving body is made up of a moving body proper and outputting means for extracting an output of the moving body and the moving body proper and the outputting means are integrally molded using an insulating material.

4. An ultrasonic motor according to claim 3, wherein the insulating material is reinforced with at least one among glass fiber, glass beads and mica.

5. An ultrasonic motor according to claim 1, wherein an oscillating body constituting the oscillating member is made of metal and an insulating layer is provided on parts of the oscillating body contacting with the moving body.

6. An ultrasonic motor according to claim 5, wherein the insulating layer is made of an engineering ceramic such as alumina, zirconia or silicon nitride.

7. An ultrasonic motor according to claim 1, wherein an oscillating body constituting the oscillating member is made of aluminum or aluminum alloy and has faces thereof contacting with the moving body alumited.

8. An ultrasonic motor according to claim 1, wherein the volume resistivity of the insulating material is above 10⁵ Ω -cm.

9. An electronic device comprising an ultrasonic motor according to any one of claims 1 through 8 and output transmitting means for transmitting an output torque from outputting means provided on the moving body.
